(19) United States
(12) Patent Application Publication
(10) Pub. No.: US 2025/0316816 A1
(43) Pub. Date: Oct. 9, 2025

(54) BATTERY PACK

(71) Applicants: Hyundai Motor Company, Seoul (KR); Kia Corporation, Seoul (KR)

(72) Inventors: Kyung Mo Kim, Hwaseong-si (KR); Jong Gyu Park, Hwaseong-si (KR); Gun Woo Ko, Hwaseong-si (KR); Chan Sol Kim, Hwaseong-si (KR)

(21) Appl. No.: 18/960,275

(22) Filed: Nov. 26, 2024

(30) Foreign Application Priority Data
Apr. 8, 2024 (KR) 10-2024-0047548

(51) Int. Cl. H01M 50/242; H01M 50/249; H01M 50/271; H01M 50/291

(52) U.S. Cl. CPC H01M 50/242; H01M 50/249; H01M 50/271; H01M 50/291

(57) ABSTRACT

An embodiment battery pack includes a battery housing defining a receiving space, battery cells accommodated in the receiving space and arranged in a first direction, a pack cover covering first sides of the battery cells facing in a second direction crossing the first direction, a plate disposed between the battery cells, and a clamp member, wherein a partial region of the clamp member is disposed between the plate and the pack cover in the second direction and is in contact with the plate.

### CROSS-REFERENCE TO RELATED APPLICATIONS

This application claims the benefit of Korean Patent Application No. 10-2024-0047548, filed on Apr. 8, 2024, which application is hereby incorporated herein by reference.

### TECHNICAL FIELD

The present disclosure relates to a battery pack.

### BACKGROUND

In recent years, research and development on electric vehicles, which are environmentally friendly vehicles, has been emphasized as crisis awareness of environments and oil resource depletion has increased. The electric vehicles include a plug-in hybrid electric vehicle (PHEV), a battery electric vehicle (BEV), a fuel cell electric vehicle (FCEV), and the like.

An electric vehicle may include a battery housing supporting battery cells. The electric vehicle may use the battery cells in the battery housing as a power source.

Meanwhile, when impact is applied to the electric vehicle, it is necessary to alleviate the impact transmitted to the battery cells in the battery housing. Accordingly, there is an increasing need for a battery pack capable of alleviating impact transmitted to battery cells when the impact is applied to the battery pack.

### SUMMARY

Embodiments of the present disclosure can solve problems occurring in the prior art while advantages achieved by the prior art are maintained intact.

An embodiment of the present disclosure provides a battery pack for alleviating impact transmitted to battery cells when the impact is applied to the battery pack.

The technical problems solvable by embodiments of the present disclosure are not limited to the aforementioned problems, and any other technical problems not mentioned herein will be clearly understood from the following description by those skilled in the art to which the present disclosure pertains.

According to an embodiment of the present disclosure, a battery pack includes a battery housing that defines a receiving space, battery cells accommodated in the receiving space and arranged in a first direction, a pack cover that covers first sides of the battery cells that face in a second direction crossing the first direction, a plate disposed between the battery cells, and a clamp member, wherein a partial region of the clamp member is disposed between the plate and the pack cover in the second direction and is in contact with the plate.

The clamp member may include a base part in contact with one surface of the pack cover that faces the battery cells and a coupling part that extends from the base part to an opposite side in the second direction with the plate therebetween and that is brought into close contact with the plate.

A width of the base part in the first direction may be greater than a width of the plate in the first direction.

The coupling part may be hooked to the plate.

The coupling part may be provided in a pair. The pair of coupling parts may include protruding ribs that protrude toward each other, and the plate may include a rib groove into which the protruding ribs are inserted.

The plate may include a cell contact part disposed between the battery cells and an extension part that extends from the cell contact part to one side in the second direction and that is coupled with the clamp member.

The plate may include a cell contact part disposed between the battery cells and a cell support part that extends from the cell contact part in the first direction to support first ends of the battery cells that face in the second direction.

The cell support part may include a first cell support part that extends from the cell contact part toward one side in the first direction and a second cell support part that is spaced apart from the first cell support part in a third direction crossing the first direction and the second direction and that extends from the cell contact part toward an opposite side in the first direction.

The plate may include an extension part that is disposed between the first cell support part and the second cell support part and that extends from the cell contact part to one side in the second direction so as to be coupled with the clamp member.

The cell support part may include a first end connected to the cell contact part, a second end spaced apart from the cell contact part in the first direction, and a convex portion provided between the first end and the second end and having a convex shape toward one side in the second direction.

The cell support part may further include a flat portion that is disposed between the convex portion and the second end and that extends in the first direction.

According to another embodiment of the present disclosure, a battery pack includes a battery housing that defines a receiving space, battery cells accommodated in the receiving space and arranged in a first direction, a pack cover that covers first sides of the battery cells that face in a second direction crossing the first direction, and a plate including a cell contact part disposed between the battery cells and a cover contact part that extends in the first direction from a first end of the cell contact part in the second direction, the cover contact part being in contact with the pack cover.

The cover contact part may be spaced apart from the battery cells in the second direction.

The plate may further include a cell support part that is spaced apart from the cover contact part in a third direction crossing the first direction and the second direction and that extends from the first end of the cell contact part in the first direction to support a first end of the battery cell that faces in the second direction.

The cell support part may include a first cell support part that extends from the first end of the cell contact part toward one side in the first direction and a second cell support part that is spaced apart from the first cell support part in the third direction and that extends from the first end of the cell contact part toward an opposite side in the first direction.

The cover contact part may be disposed between the first cell support part and the second cell support part.

The cell support part may include a first end connected to the cell contact part, a second end spaced apart from the cell contact part in the first direction, and a convex portion disposed between the first end and the second end and having a convex shape toward one side in the second direction.

The cell support part may further include a flat portion that is disposed between the convex portion and the second end and that extends in the first direction.

The cover contact part may include a first end connected to the cell contact part and a second end spaced apart from the cell contact part in the first direction.

A width of the cover contact part may be configured to correspond to a width of the cell contact part in the first direction.

### BRIEF DESCRIPTION OF THE DRAWINGS

The above and other objects, features, and advantages of embodiments of the present disclosure will be more apparent from the following detailed description taken in conjunction with the accompanying drawings, in which:

FIG. 1 is an exploded perspective view of a battery pack according to an embodiment of the present disclosure;

FIG. 2 is an enlarged view of battery cells and surrounding components accommodated in a battery housing according to an embodiment of the present disclosure;

FIG. 3 is a perspective view of a clamp member and a plate according to an embodiment of the present disclosure;

FIG. 4 is a perspective view of the clamp member according to an embodiment of the present disclosure;

FIG. 5 is a bottom perspective view of the clamp member according to an embodiment of the present disclosure;

FIG. 6 is an enlarged view of battery cells and surrounding components accommodated in a battery housing according to another embodiment of the present disclosure;

FIG. 7 is a perspective view of a plate and a clamp member according to the other embodiment of the present disclosure;

FIG. 8 is a vertical sectional view of the plate and surrounding components supporting the battery cells according to the other embodiment of the present disclosure;

FIG. 9 is an enlarged view of battery cells and surrounding components accommodated in a battery housing according to another embodiment of the present disclosure;

FIG. 10 is a sectional view of a plate brought into contact with a pack cover according to the other embodiment of the present disclosure; and

FIG. 11 is a vertical sectional view of the plate according to the other embodiment of the present disclosure.

### DETAILED DESCRIPTION OF ILLUSTRATIVE EMBODIMENTS

Hereinafter, some embodiments of the present disclosure will be described in detail with reference to the exemplary drawings. In adding the reference numerals to the components of each drawing, it should be noted that the identical or equivalent component is designated by the identical numeral even when it is displayed on other drawings. Further, in describing the embodiments of the present disclosure, a detailed description of well-known features or functions will be omitted in order not to unnecessarily obscure the gist of the embodiments of the present disclosure.

In describing the components of the embodiments according to the present disclosure, terms such as first, second, “A,” “B,” (a), (b), and the like may be used. These terms are merely intended to distinguish one component from another component, and the terms do not limit the nature, sequence, or order of the components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and they are not to be interpreted as having ideal or excessively formal meanings unless clearly defined as having such in the present application.

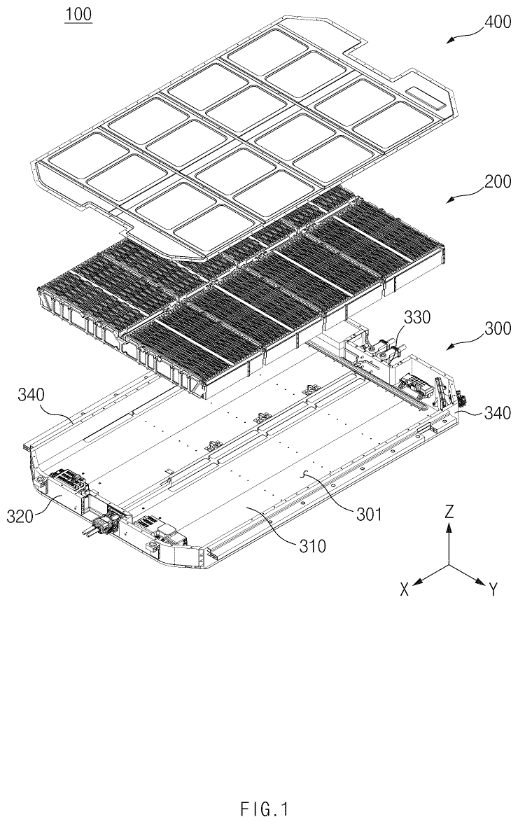

Hereinafter, embodiments of the present disclosure will be described in detail with reference to FIGS. 1 to 11.

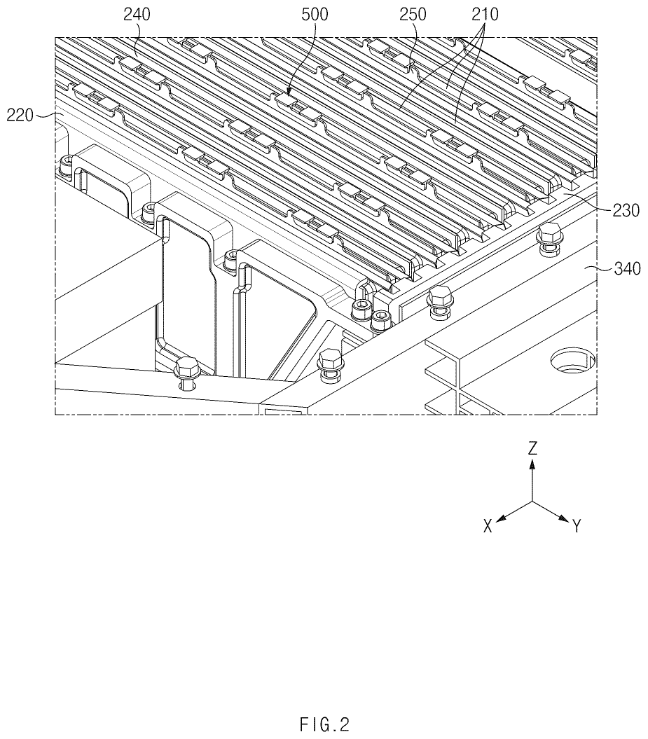

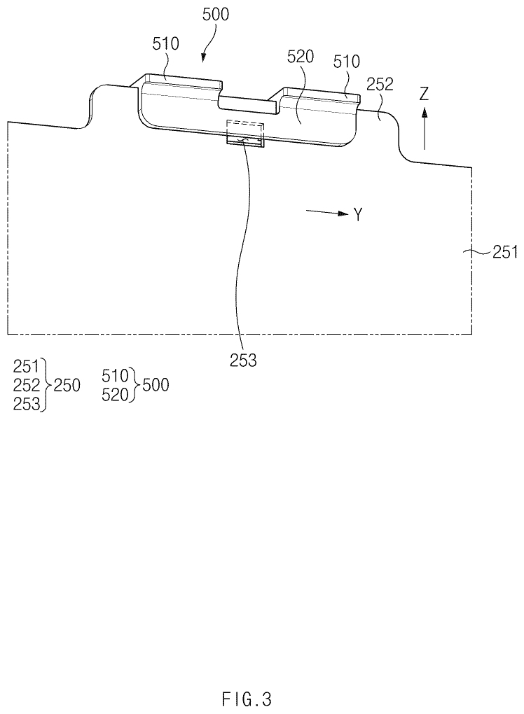

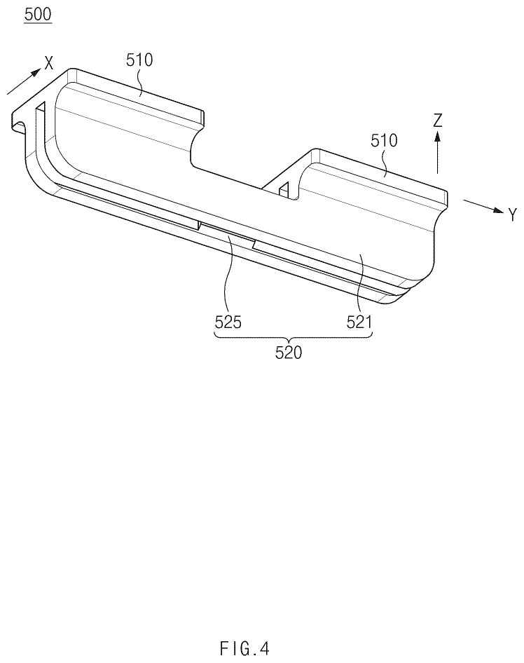

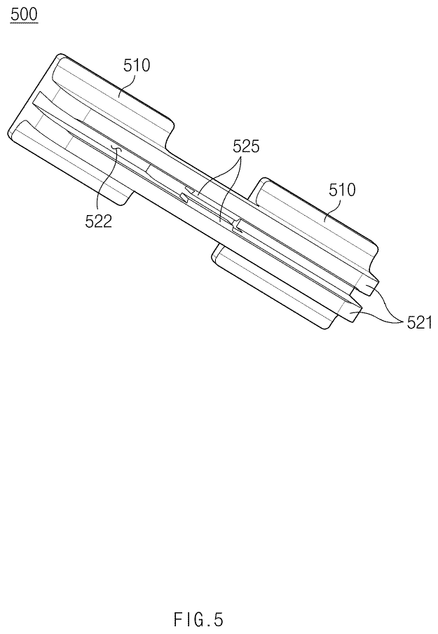

FIG. 1 is an exploded perspective view of a battery pack according to an embodiment of the present disclosure. FIG. 2 is an enlarged view of battery cells and surrounding components accommodated in a battery housing according to an embodiment of the present disclosure. FIG. 3 is a perspective view of a clamp member and a plate according to an embodiment of the present disclosure. FIG. 4 is a perspective view of the clamp member according to an embodiment of the present disclosure. FIG. 5 is a bottom perspective view of the clamp member according to an embodiment of the present disclosure.

Referring to FIGS. 1 to 5, a battery pack 100 may include a battery cell stack 200, a battery housing 300 in which the battery cell stack 200 is accommodated, and a pack cover 400.

The battery cell stack 200 may include the plurality of battery cells 210. Each of the battery cells 210 may be implemented with a lithium ion battery, but is not limited thereto. The plurality of battery cells 210 may be accommodated in the battery housing 300 without a separate module frame. That is, the battery cells 210 according to embodiments of the present disclosure may be mounted in the battery pack 100 in a cell-to-pack (CTP) configuration. However, without being limited thereto, the battery cells 210 may be equipped with a separate module frame and may be accommodated in the battery housing 300.

The battery cells 210 may be arranged in a first direction (the X-direction or the direction opposite to the X-direction) that is the front-rear direction. The plurality of battery cells 210 may be arranged in the first direction and may be accommodated in the battery housing 300, and the pack cover 400 may be provided on the upper side of the battery cells 210 (in the Z-direction). Hereinafter, the upper side may be one side in a second direction crossing the first direction and may be, for example, the Z-direction.

The battery housing 300 may include a base plate 310 disposed on the lower side of the battery cells 210 (in the direction opposite to the Z-direction), a front member 320 supported by the base plate 310 and disposed in front of the battery cells 210 (in the X-direction), and a rear member 330 supported by the base plate 310 and disposed behind the battery cells 210 (in the direction opposite to the X-direction). Hereinafter, the lower side may be an opposite side in the second direction crossing the first direction and may be, for example, the direction opposite to the Z-direction.

The battery housing 300 may include side members 340 disposed on the opposite sides of the base plate 310 in a third direction (the Y-direction or the direction opposite to the Y-direction) that is the left-right direction of the base plate 310. The battery housing 300 may form a receiving space 301 that is surrounded by the base plate 310, the front member 320, the rear member 330, and the pair of side members 340. The receiving space 301 may be a space for accommodating the battery cells 210.

The plurality of battery cells 210 may be arranged in the first direction, and end plates 220 may be provided on the opposite sides of the plurality of battery cells 210 in the first direction. The plurality of battery cells 210 between the pair of end plates 220 may be pressed by the end plates 220.

The battery cells 210 may be fixed by fixing frames 230 disposed on the opposite sides of the plurality of battery cells 210 in the third direction. The fixing frames 230 may have grooves formed therein into which the battery cells 210 are inserted, and the grooves may guide the positions of the battery cells 210.

Surface pressure members 240 may be disposed between the plurality of battery cells 210. The surface pressure members 240 may be components for preventing swelling of the battery cells 210 by applying pressure to the battery cells 210 not brought into contact with the end plates 220 among the plurality of battery cells 210.

Meanwhile, two battery cells 210 may be provided between two adjacent surface pressure members 240 or between the end plates 220 and the surface pressure members 240 adjacent thereto. The plate 250 may be provided between the two battery cells 210 adjacent to each other.

The plate 250 may be formed to make contact with the two battery cells 210 disposed to face each other with the plate 250 therebetween. The plate 250 may be a component for cooling the two battery cells 210 making contact with the plate 250.

The plate 250 may be formed of aluminum (Al). However, no special limitation applies to the material of the plate 250, as long as the plate 250 is able to easily absorb and radiate the heat of the battery cells 210.

The plate 250 may further protrude upward beyond the battery cells 210. The plate 250 may further protrude toward the pack cover 400 when compared to the battery cells 210.

The battery pack 100 may include the clamp member 500, at least a partial region of which is disposed between the plate 250 and the pack cover 400. The clamp member 500 may be brought into contact with the plate 250 and the pack cover 400.

Meanwhile, the battery pack 100 may be manufactured such that the pack cover 400 is disposed on the upper side of the battery cells 210. However, the battery pack 100 may be mounted in a vehicle in an inverted state. In other words, the pack cover 400 may be disposed to face toward a road surface when the battery pack 100 is mounted in the vehicle.

The reason why the battery pack 100 is mounted in the vehicle in the inverted state is because it is advantageous in terms of protecting the battery cells 210 or flames or high-temperature gases are able to be vented below the vehicle when a fire occurs in the battery pack 100.

In more detail, the battery pack 100 may be generally disposed under an occupant of the vehicle, and according to the structure in which the pack cover 400 is mounted toward the occupant, flames or high-temperature gases generated in the battery pack 100 may flow toward the occupant through the pack cover 400. In contrast, when the pack cover 400 is mounted in the vehicle to face toward the road surface, flames or high-temperature gases generated in the battery pack 100 may flow toward the road surface, and thus the safety of the occupant may be improved.

Furthermore, when the pack cover 400 of the battery pack 100 is mounted to face toward the occupant, the pack cover 400 may be damaged due to the weight of the occupant, whereas when the pack cover 400 is mounted to face toward the road surface, impact caused by the weight of the occupant may be applied to the base plate 310. In this case, the battery pack 100 may not be damaged because the base plate 310 is more rigid than the pack cover 400. In addition, due to the structure in which impact is transmitted to a cooling channel of the base plate 310, the impact may be prevented from being transmitted to the battery cells 210 when the base plate 310 is damaged, as compared with when the pack cover 400 is damaged. Accordingly, damage to the battery cells 210 may be prevented.

As described above, the pack cover 400 may be disposed adjacent to the road surface when the battery pack 100 is mounted in the vehicle in the inverted state. Accordingly, due to the recent trend toward the increase in the volume of the battery pack 100, the battery pack 100 may be mounted without a separate pack protection cover between the battery pack 100 and the road surface, and in this case, impact may be frequently applied to the pack cover 400.

Even when the battery pack 100 is mounted in the vehicle in the inverted state as described above, it is necessary to more safely protect the battery cells 210. That is, in the case of the battery pack 100 according to an embodiment of the present disclosure, it is necessary to alleviate impact transmitted from the pack cover 400 to the battery cells 210 by spacing the battery cells 210 apart from the pack cover 400. To achieve this, the clamp member 500 may be brought into close contact with the pack cover 400. The clamp member 500 may be formed of a material such as rubber to absorb impact.

When the battery pack 100 is mounted in the vehicle in the inverted state, the clamp member 500 may support the battery cell 210. In contrast, when the pack cover 400 of the battery pack 100 is mounted in the vehicle to face toward the occupant, the clamp member 500 may support the pack cover 400.

As described above, at least a partial region of the clamp member 500 may be disposed between the plate 250 and the pack cover 400 in the second direction and may be brought into contact with the plate 250 and the pack cover 400.

The clamp member 500 may be coupled to the plate 250. The plate 250 may include a cell contact part 251 disposed between the battery cells 210 and an extension part 252 that is coupled with the clamp member 500 and that extends from the cell contact part 251 to the upper side that is one side in the second direction. The extension part 252 may extend upward from the cell contact part 251 so as to be coupled with the clamp member 500. A plurality of extension parts 252 may be provided. The extension parts 252 may be spaced apart from each other in the third direction (the Y-direction or the direction opposite to the Y-direction) that is perpendicular to the first direction and the second direction.

The cell contact part 251 may extend parallel to the battery cells 210 to easily exchange heat with the battery cells 210 disposed parallel to each other with the plate 250 therebetween.

The extension parts 252 may protrude upward from the cell contact part 251, and first ends of the extension parts 252 in the second direction may not make contact with the battery cells 210.

The clamp member 500 may include a base part 510 and a coupling part 520. The base part 510 may be brought into contact with one surface of the pack cover 400 that faces the battery cells 210. The coupling part 520 may extend from the base part 510 to the lower side, which is the opposite side in the second direction, with the plate 250 therebetween and may be brought into close contact with the plate 250.

The width of the base part 510 in the first direction may be greater than the width of the plate 250 in the first direction such that the base part 510 more stably supports the plate 250 when the battery pack 100 is mounted in the vehicle in the inverted state.

A pair of base parts 510 may be provided. The base parts 510 may be spaced apart from each other in the third direction. The base parts 510 may be brought into contact with the first ends of the extension parts 252 in the second direction and the surface of the pack cover 400 that faces the battery cells 210.

A pair of coupling parts 520 may be provided. The coupling parts 520 may extend downward from the base parts 510 with the extension parts 252 therebetween. Each of the coupling parts 520 may extend downward from the pair of base parts 510.

Each of the coupling parts 520 may include a coupling body 521 connected to the base parts 510 and a protruding rib 525 protruding from the coupling body 521. An insertion hole 522 into which the plate 250 is inserted may be provided between the coupling bodies 521. The protruding ribs 525 may protrude from the coupling bodies 521 toward the insertion hole 522 in directions facing each other. The pair of protruding ribs 525 may extend from the coupling bodies 521 toward each other.

The plate 250 may include rib grooves 253 into which the protruding ribs 525 are inserted. The rib grooves 253 may be formed on opposite side surfaces of the plate 250 in the first direction such that the protruding ribs 525 are inserted into the rib grooves 253. However, without being limited thereto, the plate 250 may include a through-hole instead of the rib grooves 253. The through-hole may be formed through the plate 250 in the first direction such that the pair of protruding ribs 525 are inserted into the through-hole.

When the protruding ribs 525 of the clamp member 500 are inserted into the rib grooves 253 as described above, the protruding ribs 525 may be fastened to the plate 250, and thus the coupling parts 520 of the clamp member 500 may be hooked to the plate 250. That is, the positions of the clamp member 500 and the plate 250 may be fixed.

According to the above-described structure, when the battery pack 100 is mounted in the vehicle in the inverted state, the clamp member 500 may space the plate 250 and the pack cover 400 apart from each other, and thus the battery cells 210 pressed by the plate 250 may also be spaced apart from the pack cover 400. Due to this, when impact is applied to an area of the vehicle that is adjacent to the road surface, the impact transmitted to the battery cells 210 may be alleviated, and it may be advantageous to protect the battery cells 210.

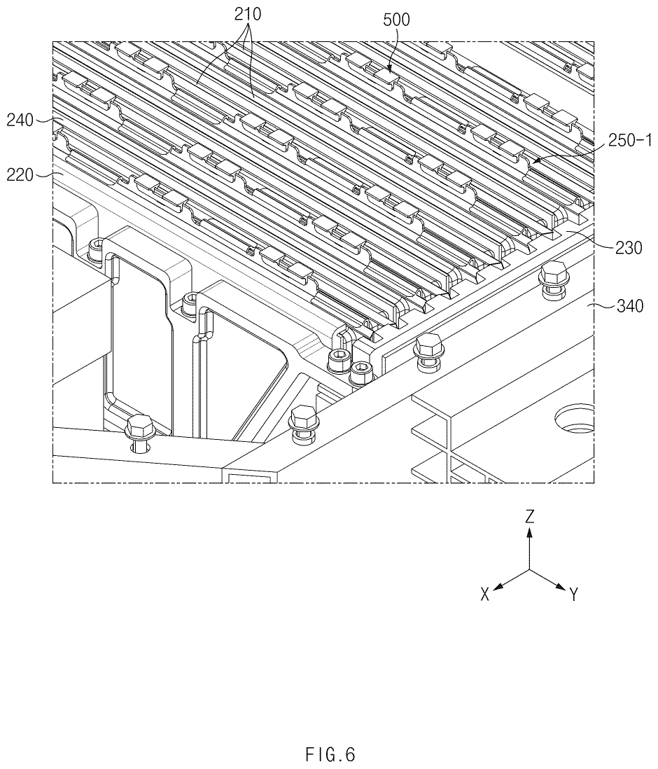

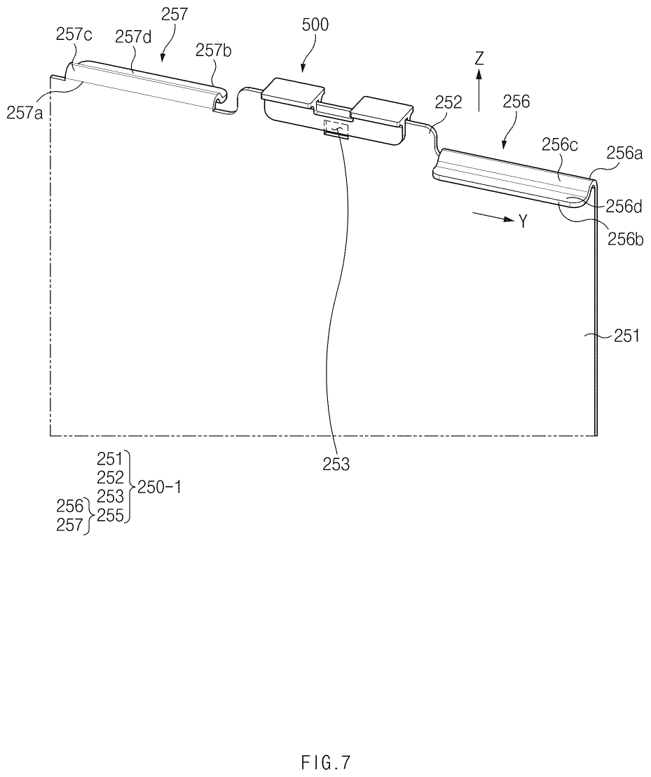

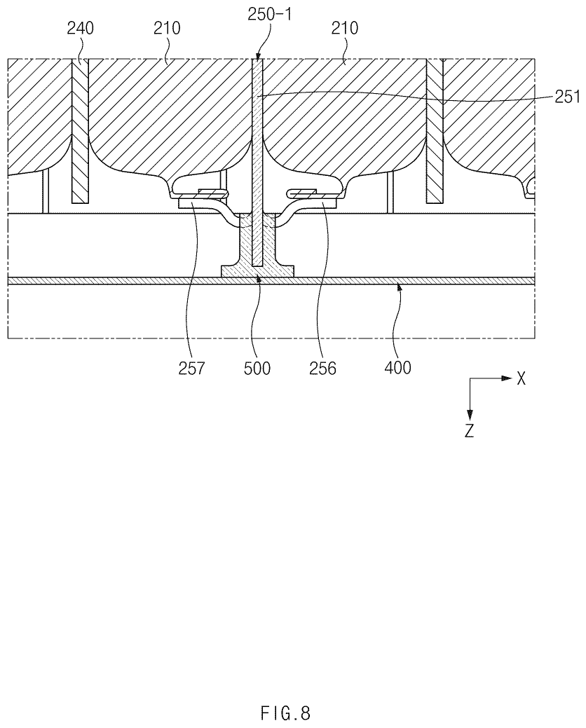

FIG. 6 is an enlarged view of battery cells and surrounding components accommodated in a battery housing according to another embodiment of the present disclosure. FIG. 7 is a perspective view of a plate and a clamp member according to the other embodiment of the present disclosure. FIG. 8 is a vertical sectional view of the plate and surrounding components supporting the battery cells according to the other embodiment of the present disclosure.

Referring to FIGS. 6 to 8, unlike the plate 250 according to one embodiment of the present disclosure, the plate 250-1 according to the other embodiment of the present disclosure may further include a cell support part 255.

Likewise to the plate 250, the plate 250-1 according to the other embodiment of the present disclosure may be coupled with the clamp member 500. Description of a cell contact part 251 and extension parts 252 of the plate 250-1 and the clamp member 500 according to the other embodiment of the present disclosure refers to the description of the plate 250 and the clamp member 500 according to one embodiment of the present disclosure.

The cell support part 255 may be a part that extends from the cell contact part 251 in the first direction to support first ends of the battery cells 210 in the second direction. The cell support part 255 may include a first cell support part 256 extending from the cell contact part to one side in the first direction and a second cell support part 257 extending from the cell contact part 251 to an opposite side in the first direction.

The first cell support part 256 and the second cell support part 257 may be spaced apart from each other in the third direction, and the extension parts 252 may be provided between the first cell support part 256 and the second cell support part 257.

The first cell support part 256 and the second cell support part 257 may extend from the cell contact part 251 in opposite directions and may support two battery cells 210 facing each other with the plate 250-1 therebetween.

The first and second cell support parts 256 and 257 may include first ends 256a and 257a connected to the cell contact part 251 and second ends 256b and 257b spaced apart from the cell contact part 251 in the first direction. The first ends 256a and 257a of the first and second cell support parts 256 and 257 may be fixed ends, and the second ends 256b and 257b of the first and second cell support parts 256 and 257 may be free ends.

The first and second cell support parts 256 and 257 may include convex portions 256c and 257c that are provided between the first ends 256a and 257a and the second ends 256b and 257b and that have a convex shape toward the upper side and flat portions 256d and 257d that are provided between the convex portions 256c and 257c and the second ends 256b and 257b and that have a flat surface shape extending in the first direction.

The convex portions 256c and 257c of the first and second cell support parts 256 and 257 may reinforce the rigidity of portions where the first and second cell support parts 256 and 257 are connected with the cell contact part 251. The flat portions 256d and 257d of the first and second cell support parts 256 and 257 may support the two adjacent battery cells 210 facing the plate 250-1.

According to the above-described structure, when the battery pack 100 (refer to FIG. 1) is mounted in the vehicle in the inverted state, the plate 250-1 coupled with the clamp member 500 may remain spaced apart from the pack cover 400 and may prevent the battery cells 210 from moving toward the pack cover 400. Accordingly, the safety of the battery cells 210 may be further improved by the plate 250-1 according to the other embodiment of the present disclosure.

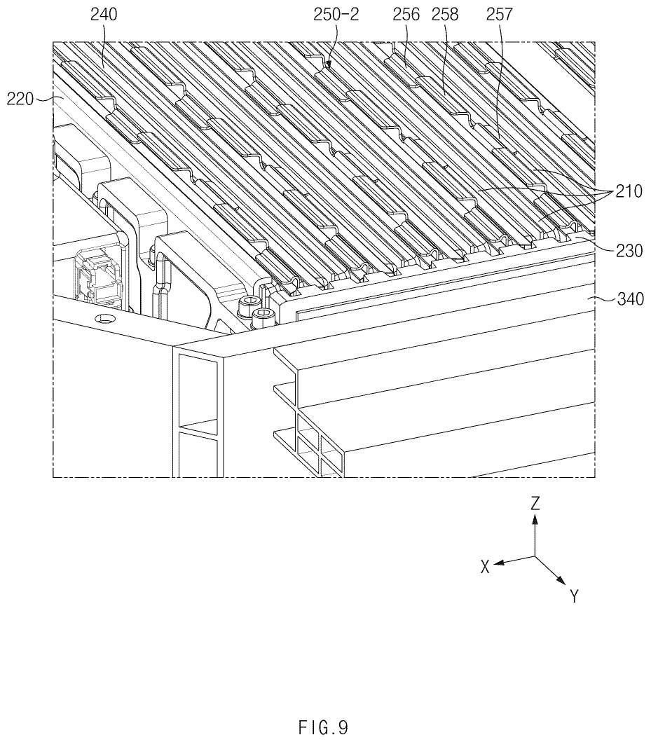

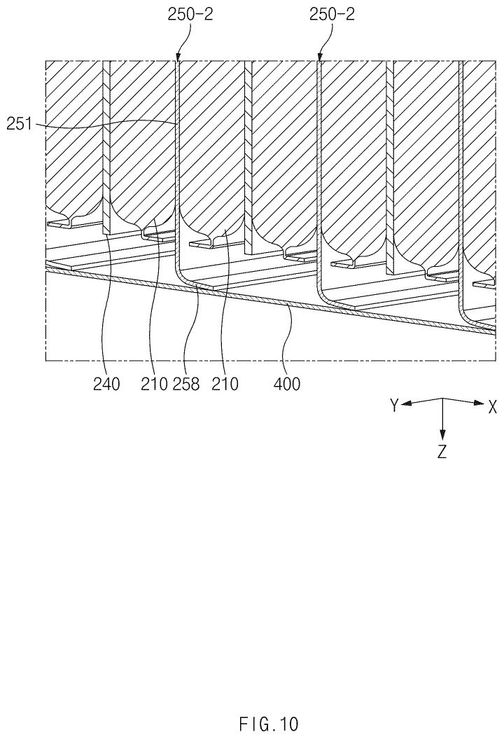

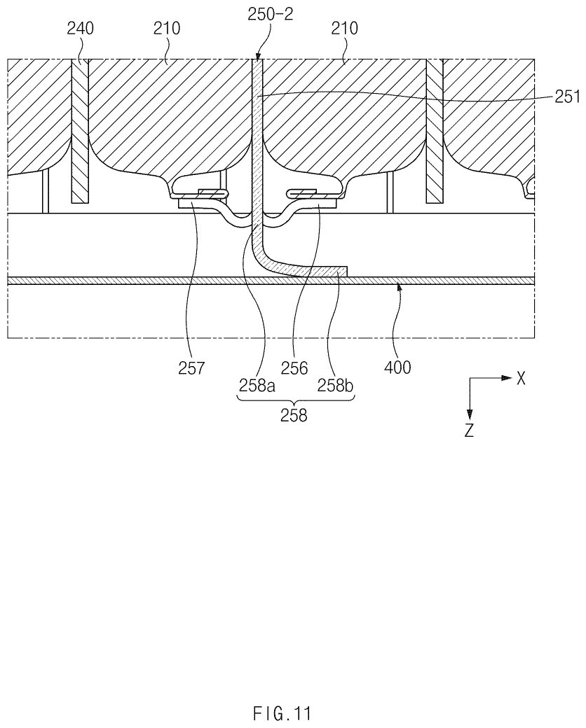

FIG. 9 is an enlarged view of battery cells and surrounding components accommodated in a battery housing according to another embodiment of the present disclosure. FIG. 10 is a sectional view of a plate brought into contact with a pack cover according to the other embodiment of the present disclosure. FIG. 11 is a vertical sectional view of the plate according to the other embodiment of the present disclosure.

Referring to FIGS. 9 to 11, unlike the above-described plates 250 and 250-1, the plate 250-2 according to the other embodiment of the present disclosure may include a cover contact part 258 instead of the extension parts 252. Description of a cell contact part 251 of the plate 250-2 according to the other embodiment of the present disclosure refers to the descriptions of the cell contact parts of the plates 250 and 250-1 described above.

The cover contact part 258 may extend in the first direction from a first end of the cell contact part 251 that faces in the second direction and may be brought into contact with the pack cover 400. That is, unlike the above-described plates 250 and 250-1, the plate 250-2 according to the other embodiment of the present disclosure has a structure directly supporting the pack cover 400 without the separate clamp member 500.

The cover contact part 258 may be formed in the area of the plate 250-2 where the extension parts 252 of the plate 250-1 illustrated in FIG. 6 are formed. The cover contact part 258 may extend toward one side in the second direction from a first end of the plate 250-2 that faces in the second direction.

The cover contact part 258 may include a first end 258a connected to the cell contact part 251 and a second end 258b that extends from the cell contact part 251 to the one side in the second direction and that is spaced apart from the cell contact part 251 in the first direction.

The cover contact part 258 may extend from the first end 258a to the one side in the second direction and may extend in the first direction. According to the above-described structure, the second end 258b of the cover contact part 258 may be brought into contact with the pack cover 400 and may be spaced apart from the battery cells 210 in the second direction.

The cover contact part 258 may be formed between a first cell support part 256 and a second cell support part 257. That is, the plate 250-2 according to the other embodiment of the present disclosure may include the first and second cell support parts 256 and 257 that are spaced apart from the cover contact part 258 in the third direction and that extend in the first direction from the first end of the cell contact part 251 facing in the second direction and support first ends of the battery cells 210 facing in the second direction.

The first cell support part 256 may extend toward one side in the first direction from the first end of the cell contact part 251 that faces in the second direction, and the second cell support part 257 may be spaced apart from the first cell support part 256 in the third direction and may extend toward an opposite side in the first direction from the first end of the cell contact part 251 that faces in the second direction.

As described above with reference to FIG. 7, the first and second cell support parts 256 and 257 may include first ends 256a and 257a connected to the cell contact part 251 and second ends 256b and 257b spaced apart from the cell contact part 251 in the first direction. The first and second cell support parts 256 and 257 may include convex portions 256c and 257c that are provided between the first ends 256a and 257a and the second ends 256b and 257b of the first and second cell support parts 256 and 257 and that have a convex shape toward the one side in the second direction. In addition, the first and second cell support parts 256 and 257 may include flat portions 256d and 257d that are provided between the convex portions 256c and 257c and the second ends 256b and 257b and that have a flat surface shape extending in the first direction. Description of the first and second cell support parts 256 and 257 refers to the description of the first and second cell support parts 256 and 257 of the plate 250-1 according to the other embodiment of the present disclosure.

The width of the cover contact part 258 provided between the first cell support part 256 and the second cell support part 257 may correspond to the width of the cell contact part 251 in the first direction. That is, the cover contact part 258 and the cell contact part 251 may have a width of about 1 mm in the first direction.

The cover contact part 258 may extend upward from the first end 258a of the cover contact part 258 and may extend to the one side or the opposite side in the first direction to reach the second end 258b of the cover contact part 258. According to the above-described structure, when the cover contact part 258 having a relatively small thickness makes contact with the pack cover 400, the portion of the cover contact part 258 that extends in the first direction may be partially pressed downward by the pack cover 400 and may be brought into close contact with the surface of the pack cover 400 that faces the battery cells 210.

That is, the cover contact part 258 may space the pack cover 400 and the battery cells 210 apart from each other in the second direction even without the separate clamp member 500. Accordingly, the pack cover 400 and the battery cells 210 may be spaced apart from each other by the plate 250-2 according to the other embodiment of the present disclosure, and when impact is applied to the pack cover 400, the impact transmitted to the battery cells 210 may be alleviated, and thus the battery cells 210 may be easily protected.

According to the structures of the plates 250, 250-1, and 250-2 described above, even when the battery pack 100 is mounted in the vehicle in the inverted state, the battery cells 210 and the pack cover 400 may be spaced apart from each other, and thus the safety of the battery cells 210 may be improved.

According to embodiments of the present disclosure, the pack cover and the battery cells may remain spaced apart from each other. Accordingly, when impact is applied to the battery pack, the impact transmitted to the battery cells may be alleviated, and thus the battery cells may be more stably supported.

Furthermore, the plate may safely support the battery cells when the battery pack is mounted in the vehicle in the inverted state, and thus the battery cells may be more safely protected.

Moreover, the plate may be brought into contact with the pack cover, and thus the battery cells may be more safely protected without a separate member.

In addition, embodiments of the present disclosure may provide various effects that are directly or indirectly recognized.

Hereinabove, although embodiments of the present disclosure have been described with reference to exemplary embodiments and the accompanying drawings, the embodiments of the present disclosure are not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. A battery pack comprising:
a battery housing defining a receiving space;
battery cells accommodated in the receiving space and arranged in a first direction;
a pack cover covering first sides of the battery cells facing in a second direction crossing the first direction;
a plate disposed between the battery cells; and
a clamp member, wherein a partial region of the clamp member is disposed between the plate and the pack cover in the second direction and is in contact with the plate.

2. The battery pack of claim 1, wherein the clamp member comprises:
a base part in contact with one surface of the pack cover facing the battery cells; and
a coupling part extending from the base part to an opposite side in the second direction with the plate therebetween and in close contact with the plate.

3. The battery pack of claim 2, wherein a width of the base part in the first direction is greater than a width of the plate in the first direction.

4. The battery pack of claim 2, wherein the coupling part is hooked to the plate.

5. The battery pack of claim 2, wherein:
the coupling part comprises a pair of coupling parts;
the pair of coupling parts comprises protruding ribs protruding toward each other; and
the plate comprises a rib groove configured to receive the protruding ribs.

6. The battery pack of claim 1, wherein the plate comprises:
a cell contact part disposed between the battery cells; and
an extension part extending from the cell contact part to one side in the second direction and coupled with the clamp member.

7. The battery pack of claim 1, wherein the plate comprises:
a cell contact part disposed between the battery cells; and
a cell support part configured to extend from the cell contact part in the first direction to support a first end of the battery cells, the first end facing in the second direction.

8. The battery pack of claim 7, wherein the cell support part comprises:
a first cell support part extending from the cell contact part toward one side in the first direction; and
a second cell support part spaced apart from the first cell support part in a third direction crossing the first direction and the second direction and extending from the cell contact part toward an opposite side in the first direction.

9. The battery pack of claim 8, wherein the plate comprises an extension part disposed between the first cell support part and the second cell support part and extending from the cell contact part to one side in the second direction so as to be coupled with the clamp member.

10. The battery pack of claim 7, wherein the cell support part comprises:
a first end connected to the cell contact part;
a second end spaced apart from the cell contact part in the first direction; and
a convex portion disposed between the first end and the second end and having a convex shape toward one side in the second direction.

11. The battery pack of claim 10, wherein the cell support part further comprises a flat portion disposed between the convex portion and the second end and extending in the first direction.

12. A battery pack comprising:
a battery housing defining a receiving space;
battery cells accommodated in the receiving space and arranged in a first direction;
a pack cover covering first sides of the battery cells facing in a second direction crossing the first direction; and
a plate comprising:
a cell contact part disposed between the battery cells; and
a cover contact part extending in the first direction from a first end of the cell contact part in the second direction, the cover contact part being in contact with the pack cover.

13. The battery pack of claim 12, wherein the cover contact part is spaced apart from the battery cells in the second direction.

14. The battery pack of claim 12, wherein the plate further comprises a cell support part spaced apart from the cover contact part in a third direction crossing the first direction and the second direction and extending from the first end of the cell contact part in the first direction to support a first end of the battery cells facing in the second direction.

15. The battery pack of claim 14, wherein the cell support part comprises:
a first cell support part extending from the first end of the cell contact part toward one side in the first direction; and
a second cell support part spaced apart from the first cell support part in the third direction and extending from the first end of the cell contact part toward an opposite side in the first direction.

16. The battery pack of claim 15, wherein the cover contact part is disposed between the first cell support part and the second cell support part.

17. The battery pack of claim 14, wherein the cell support part comprises:
a first end connected to the cell contact part;
a second end spaced apart from the cell contact part in the first direction; and
a convex portion disposed between the first end and the second end and having a convex shape toward one side in the second direction.

18. The battery pack of claim 17, wherein the cell support part further comprises a flat portion disposed between the convex portion and the second end and extending in the first direction.

19. The battery pack of claim 12, wherein the cover contact part comprises a first end connected to the cell contact part and a second end spaced apart from the cell contact part in the first direction.

20. The battery pack of claim 19, wherein a width of the cover contact part corresponds to a width of the cell contact part in the first direction.
